(19) United States
(12) Patent Application Publication
(10) Pub. No.: US 2025/0216685 A1
(43) Pub. Date: Jul. 3, 2025

(54) SMART GLASSES, METHOD AND APPARATUS FOR CALIBRATING SMART GLASSES AND STORAGE MEDIUM

(71) Applicant: GOERTEK TECHNOLOGY CO., LTD., Qingdao (CN)

(72) Inventor: Tao DUAN, Qingdao (CN)

(21) Appl. No.: 19/084,965

(22) Filed: Mar. 20, 2025

Related U.S. Application Data
(63) Continuation of application No. PCT/CN2023/124749, filed on Oct. 16, 2023.

(30) Foreign Application Priority Data
Oct. 25, 2022 (CN) 202211312031.1

(51) Int. Cl. G02B 27/01

(52) U.S. Cl. CPC G02B 27/0172; G02B 2027/014; G02B 2027/0178

(57) ABSTRACT

A smart glass, a method, an apparatus for calibrating the smart glasses and a storage medium. The smart glasses include: a first frame, a second frame and a processing device. The first frame is provided with a reflective surface and a first optical machine; the second frame is provided with a light transmitter, a light receiver and a second optical machine; and the processing device is electrically connected to the light transmitter and the light receiver respectively to obtain a standard position of a light spot and a deformation position of the light spot, determine a deformation position of the first optical machine according to the standard position of the light spot and the deformation position of the light spot, and determine a correction amount of the first optical machine according to the standard position of the first optical machine and the deformation position of the first optical machine.

### CROSS-REFERENCE TO RELATED APPLICATIONS

This application is a continuation application of International Application No. PCT/CN2023/124749, filed on Oct. 16, 2023, which claims priority to Chinese Patent Application No. 202211312031.1, filed on Oct. 25, 2022. The disclosures of the above-mentioned applications are incorporated herein by reference in their entireties.

### TECHNICAL FIELD

The present application relates to the technical field of wearable devices, and in particular to a smart glass, a method for calibrating a smart glasses, an apparatus for calibrating a smart glasses and a storage medium.

### BACKGROUND

In recent years, binocular smart glasses, such as Augmented Reality (AR) glasses, Virtual Reality (VR) glasses, and Mixed Reality (MR) glasses, have been increasingly used widely.

At present, binocular smart glasses require sufficient rigidity of the front frame to avoid deformation and ensure binocular fusion and binocular vision Six Degrees Of Freedom (6DOF) effects. Therefore, the structural design of the front frame of existing binocular smart glasses needs to be strong enough. This is not conducive to the miniaturization and lightweight of binocular smart glasses.

### SUMMARY

The main purpose of the present application is to provide a new technical solution for smart glasses.

According to a first aspect, the present application provides a smart glasses, including: a first frame; a second frame; and a processing device.

The first frame is provided with a reflective surface and a first optical machine, and a relative position between the reflective surface and the first optical machine is fixed.

The second frame is provided with a light transmitter, a light receiver and a second optical machine, and a relative position between the light transmitter, the light receiver and the second optical machine is fixed.

The processing device is electrically connected to the light transmitter and the light receiver, respectively, and the processing device is configured for:
obtaining a standard position of a light spot and a deformation position of the light spot;
determining a deformation position of the first optical machine according to the standard position of the light spot and the deformation position of the light spot; and
determining a correction amount of the first optical machine according to the standard position of the first optical machine and the deformation position of the first optical machine; and
light emitted by the light transmitter is reflected by the reflective surface to the light receiver to form the light spot.

In an embodiment, the processing device is further configured for:
obtaining a wearing state of the smart glasses; and
in response to that the wearing state is being worn, turning on the light transmitter and the light receiver.

In an embodiment, the determining the deformation position of the first optical machine according to the standard position of the light spot and the deformation position of the light spot includes:
determining a rotation angle of the reflective surface according to the standard position of the light spot and the deformation position of the light spot;
determining a deformation position of the reflective surface according to the rotation angle and a standard position of the reflective surface; and
determining the deformation position of the first optical machine according to the deformation position of the reflective surface.

In an embodiment, the light transmitter is an infrared light transmitter or a laser transmitter.

According to a second aspect, the present application provides a method for calibrating a smart glasses, applied to the smart glasses as described in the first aspect, including:
obtaining the standard position of the light spot and the deformation position of the light spot;
determining the deformation position of the first optical machine according to the standard position of the light spot and the deformation position of the light spot; and
determining the correction amount of the first optical machine according to the standard position of the first optical machine and the deformation position of the first optical machine;
the light emitted by the light transmitter is reflected by the reflective surface to the light receiver to form the light spot.

In an embodiment, before the obtaining the standard position of the light spot and the deformation position of the light spot, the method further includes:
obtaining a wearing state of the smart glasses; and
in response to that the wearing state is being worn, turning on the light transmitter and the light receiver.

In an embodiment, the determining the deformation position of the first optical machine according to the standard position of the light spot and the deformation position of the light spot includes:
determining a rotation angle of the reflective surface according to the standard position of the light spot and the deformation position of the light spot;
determining a deformation position of the reflective surface according to the rotation angle and a standard position of the reflective surface; and
determining the deformation position of the first optical machine according to the deformation position of the reflective surface.

According to a third aspect, the present application provides an apparatus for calibrating a smart glasses, applied to the smart glasses as described in the first aspect, including:
an obtainment module, configured to obtain the standard position of the light spot and the deformation position of the light spot;
a first determination module, configured to determine the deformation position of the first optical machine according to the standard position of the light spot and the deformation position of the light spot; and
a second determination module, configured to determine the correction amount of the first optical machine according to the standard position of the first optical machine and the deformation position of the first optical machine,
the light emitted by the light transmitter is reflected by the reflective surface to the light receiver to form the light spot.

According to a forth aspect, the present application provides a smart glasses, including the apparatus for calibrating a smart glasses as described in the third aspect; or including a memory and a processor. The computer instruction is stored in the memory, and the processor is configured to call the computer instruction from the memory to execute the method for calibrating the smart glasses as described in the second aspect

According to a fifth aspect, the present application provides a non-transitory computer-readable storage medium, a computer program is stored in the non-transitory computer-readable storage medium, and the computer program, when executed by a processor, implements the method for calibrating the smart glasses as described in the second aspect.

The embodiment of the present application provides a smart glasses, including: a first frame, a second frame and a processing device. The first frame is provided with a reflective surface and a first optical machine, and the relative position between the reflective surface and the first optical machine is fixed. The second frame is provided with a light transmitter, a light receiver and a second optical machine, and the relative position between the light transmitter, the light receiver and the second optical machine is fixed. The processing device is electrically connected to the light transmitter and the light receiver, respectively, to obtain the standard position of the light spot and the deformation position of the light spot, to determine the deformation position of the first optical machine according to the standard position of the light spot and the deformation position of the light spot, and to determine the correction amount of the first optical machine according to the standard position of the first optical machine and the deformation position of the first optical machine. The light emitted by the light transmitter is reflected by the reflective surface to the light receiver to form a light spot. Through the embodiment of the present application, there is no need to limit the rigidity of the frame of the smart glasses, thereby meeting the requirements of miniaturization and lightweight of the smart glasses.

Other features and advantages of the present application will become apparent from the following detailed description of exemplary embodiments of the present application with reference to the accompanying drawings.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art other drawings can be obtained based on the structures shown in these drawings without creative work.

FIG. 1 is a schematic structure diagram of a smart glasses according to an embodiment of the present application.

FIG. 2 is a schematic diagram of a relative position between a light transmitter, a light receiver, and a reflective surface according to an embodiment of the present application.

FIG. 3 is a schematic diagram of a relative position between the light transmitter, the light receiver, and the reflective surface according to another embodiment of the present application.

FIG. 4 is a flowchart of a method for calibrating a smart glasses according to another embodiment of the present application.

FIG. 5 is a schematic diagram of a calculation principle of a rotation angle of the reflective surface according to an embodiment of the present application.

FIG. 6 is a flowchart of a method for calibrating a smart glasses according to an embodiment of the present application.

FIG. 7 is a schematic structure diagram of an apparatus for calibrating a smart glasses according to an embodiment of the present application.

FIG. 8 is a schematic structure diagram of a smart glasses according to another embodiment of the present application.

### DETAILED DESCRIPTION OF THE EMBODIMENTS

The following will describe the technical solutions in the embodiments of the present application in conjunction with the drawings in the embodiments of the present application. Obviously, the described embodiments are only part of the embodiments of the present application, not all of the embodiments. Based on the embodiments in the present application, all other embodiments obtained by those skilled in the art without creative work are within the scope of protection of this application.

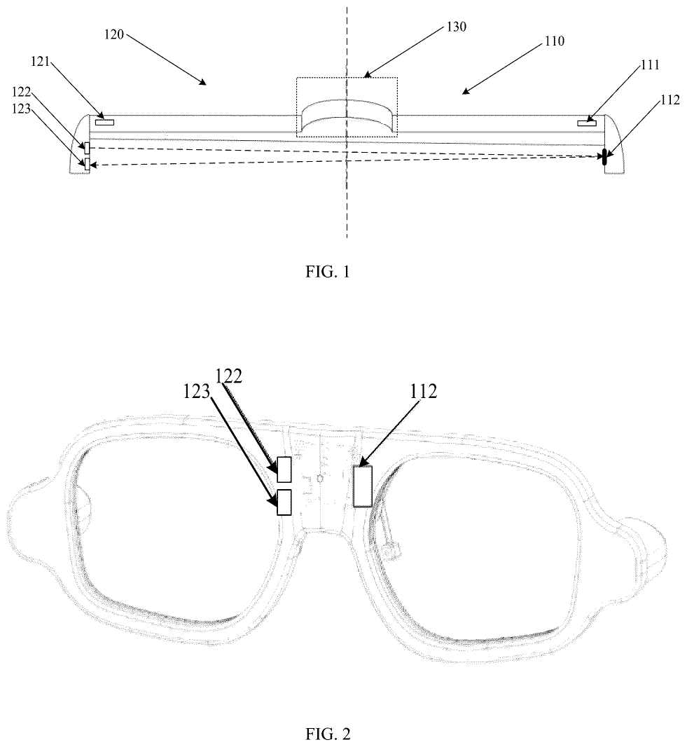

The embodiment of the present application provides a smart glasses, as shown in FIG. 1, the smart glasses includes a first frame 110, a second frame 120 and a processing device.

The first frame 110 is provided with a reflective surface 112 and a first optical machine 111, and a relative position between the reflective surface 112 and the first optical machine 111 is fixed.

The second frame 120 is provided with a light transmitter 122, a light receiver 123 and a second optical machine 121, and a relative position between the light transmitter 122 the light receiver 123 and the second optical machine 121 is fixed.

The processing device is electrically connected to the light transmitter 122 and the light receiver 123 respectively to obtain the standard position of the light spot and the deformation position of the light spot, to determine the deformation position of the first optical machine 111 according to the standard position of the light spot and the deformation position of the light spot, and to determine the deformation position of the first optical machine 111 according to the standard position of the light spot and the deformation position of the light spot, and to determine the correction amount of the first optical machine 111 according to the standard position of the first optical machine and the deformation position of the first optical machine.

The light emitted by the light transmitter 122 is reflected by the reflective surface to the light receiver 123 to form a light spot. The standard position of the light spot is the position of the light spot when the smart glasses are not deformed. The deformation position of the light spot is the position of the light spot when the smart glasses are deformed. The standard position of the first optical machine 111 is the position of the first optical machine 111 when the smart glasses are not deformed. The deformation position of the first optical machine 111 is the position of the first optical machine 111 when the smart glasses are deformed. The coordinate systems corresponding to the standard position of the light spot, the deformation position of the light spot, the standard position of the first optical machine 111 and the deformation position of the first optical machine 111 are the same and are all the coordinate systems corresponding to the light transmitter 122, the light receiver 123 or the second optical machine 121.

It should be noted that the processing device is not shown in FIG. 1, and the processing device can be set at any position of the smart glasses that does not block the wearer's field of view. The dotted lines with arrows in FIG. 1 respectively indicate the light emitted by the light transmitter 122 and the light reflected by the reflective surface 112.

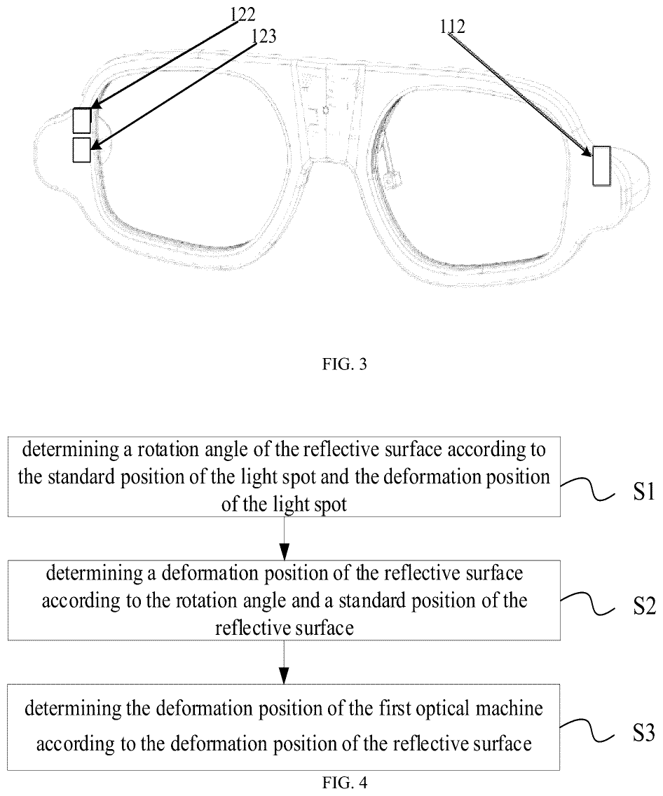

In an embodiment, the positions of the light transmitter 122, the light receiver 123 and the reflective surface 112 can also be as shown in FIG. 2 and FIG. 3. The positions of the light transmitter 122, the light receiver 123 and the reflective surface 112 can also be other, as long as they can meet the limitations of the light transmitter 122, the light receiver 123 and the reflective surface 112 in the embodiment of the present application.

In addition, the first optical machine 111 and the reflective surface 112 can be set close to each other to achieve a fixed relative position between the two regardless of whether the smart glasses are deformed. And, the second optical machine 121, the light transmitter 122 and the light receiver 123 can be set close to each other to achieve a fixed relative position between the three regardless of whether the smart glasses are deformed.

In the embodiment of the present application, the first frame is the frame corresponding to the left lens of the smart glasses, and the second frame is the frame corresponding to the right lens of the smart glasses. Or, the first frame is the frame corresponding to the right lens of the smart glasses, and the second frame is the frame corresponding to the left lens of the smart glasses.

Taking the first frame as the frame corresponding to the right lens of the smart glasses as an example, the first optical machine 111 is the optical machine of the right lens, which is used to project an image to the right lens according to the display signal of the right lens. On the basis, the second optical machine 121 is the optical machine of the left lens, which is used to project an image to the left lens according to the display signal of the left lens.

The light transmitter 122 is used to emit light toward the reflective surface 112. The reflective surface 112 is used to reflect the light emitted by the light transmitter 122. The light reflected by the reflective surface 112 forms a light spot on the light receiver 123. The light receiver 123 is used to sense the light spot formed thereon.

In the embodiment of the present application, when the smart glasses are worn, due to the difference in the wearer's face, the smart glasses may be deformed. As shown in FIG. 1, the deformed area 130 is usually the connection between the first frame and the second frame of the smart glasses.

In the embodiment of the present application, the reference coordinate system of the smart glasses is the coordinate system of the light transmitter 122, the light receiver 123 or the second optical machine 121. Taking the reference coordinate system of the smart glasses as the coordinate system of the light transmitter 122 as an example, the coordinate origin of the reference coordinate system can be the center point of the light transmitter 122.

Since the relative positions between the second optical machine 121, the light transmitter 122 and the light receiver 123 are fixed, and the reference coordinate system of the smart glasses is the coordinate system of the second optical machine 121, the light transmitter 122 or the light receiver 123, even if the smart glasses are deformed, the positions of the second optical machine 121, the light transmitter 122 and the light receiver 123 in the reference coordinate system do not change. In this way, there is no offset in the image projected by the second optical machine 121 to the corresponding lens.

When the smart glasses are deformed, the position of the reflective surface 112 relative to the second optical machine 121 (or the light transmitter 122, or the light receiver 123) changes, and the position of the light spot changes accordingly. On the basis, based on the deformation position of the light spot and the standard position of the light spot, the change of the reflective surface 112 can be reflected. Further, combined with the standard position of the reflective surface 112, the deformation position of the reflective surface 112 can be determined. Since the relative position between the reflective surface 112 and the first optical machine 111 is fixed, the deformation position of the first optical machine 111 can be determined based on the deformation position of the reflective surface 112.

Further, based on the difference between the deformation position of the first optical machine 111 and the standard position of the first optical machine 111, the correction amount of the first optical machine 111 can be determined. The first optical machine 111 projects the picture to the corresponding lens based on the correction amount, which can avoid the image from being offset. In this way, there is no need to limit the rigidity of the frame of the smart glasses, thereby meeting the requirements of miniaturization and lightweight of the smart glasses.

The standard position of the light spot can be obtained by the developer calibrating the light spot in the reference coordinate system before the smart glasses leave the factory and without deformation. Similarly, the standard position of the reflective surface 112 can be obtained by the developer calibrating the reflective surface 112 in the reference coordinate system before the smart glasses leave the factory and without deformation. And, the standard position of the first optical machine 111 can be obtained by the developer calibrating the first optical machine 111 in the reference coordinate system before the smart glasses leave the factory and without deformation.

In addition, the correction amount of the first optical machine 111 is: the difference between the standard position of the first optical machine 111 and the deformation position of the first optical machine 111.

The embodiment of the present application provides a smart glasses, including: a first frame, provided with a reflective surface and a first optical machine, the relative position between the reflective surface and the first optical machine is fixed; a second frame, provided with a light transmitter, a light receiver and a second optical machine, the relative position between the light transmitter, the light receiver and the second optical machine is fixed; and a processing device, electrically connected to the light transmitter and the light receiver, respectively to obtain the standard position of the light spot and the deformation position of the light spot, to determine the deformation position of the first optical machine according to the standard position of the light spot and the deformation position of the light spot, and to determine the correction amount of the first optical machine according to the standard position of the first optical machine and the deformation position of the first optical machine; the light emitted by the light transmitter is reflected by the reflective surface to the light receiver to form a light spot. Through the embodiment of the present application, there is no need to limit the rigidity of the frame of the smart glasses, thereby meeting the requirements of miniaturization and lightweight of the smart glasses.

In an embodiment of the present application, the processing device is also configured to obtain the wearing state of the smart glasses, and in response to that the wearing state is being worn, turn on the light transmitter 122 and the light receiver 123.

The wearing state of the smart glasses includes being worn and not being worn.

In the embodiment of the present application, when the wearing state is being worn, it means that the smart glasses are likely to be used. At this time, the light transmitter 122 and the light receiver 123 are turned on to determine the correction amount of the first optical machine 111. In this way, invalid turning on the light transmitter 122 and the light receiver 123 can be avoided.

Correspondingly, when the wearing state is not being worn, it means that the smart glasses are not likely to be used. At this time, the light transmitter 122 and the light receiver 123 are turned off. This can save the power consumption of the smart glasses.

The wearer can notify the smart glasses of the wearing state of the smart glasses by voice input or key input.

In order to enable the smart glasses to actively detect their own wearing state to improve the intelligence of the smart glasses, the smart glasses provided in the embodiment of the present application also include:
a wearing detection device, which is provided on the smart glasses and is electrically connected to the processing device; and when the wearing state of the smart glasses is being worn, the wearing detection device can contact the wearer.

In the embodiment of the present application, the wearing detection device can be a pressure sensor. Since the wearing detection device can contact the wearer when the wearing state of the smart glasses is being worn, when the pressure value detected by the pressure sensor is greater than 0, the wearing state of the smart glasses is determined to be worn, otherwise, the wearing state of the smart glasses is determined to be not worn.

The wearing detection device can also be other, such as a distance sensor, etc.

In an embodiment of the present application, as shown in FIG. 4, the step of determining the deformation position of the first optical machine 111 according to the standard position of the light spot and the deformation position of the light spot includes the following steps:
S1, determining a rotation angle of the reflective surface according to the standard position of the light spot and the deformation position of the light spot;
S2, determining a deformation position of the reflective surface according to the rotation angle and a standard position of the reflective surface; and
S3, determining the deformation position of the first optical machine according to the deformation position of the reflective surface.

It should be noted that in the embodiment of the present application, the light transmitter 122 and the light receiver are located in the same plane, and the plane where the light transmitter 122 is located is parallel to the plane where the reflective surface 112 is located.

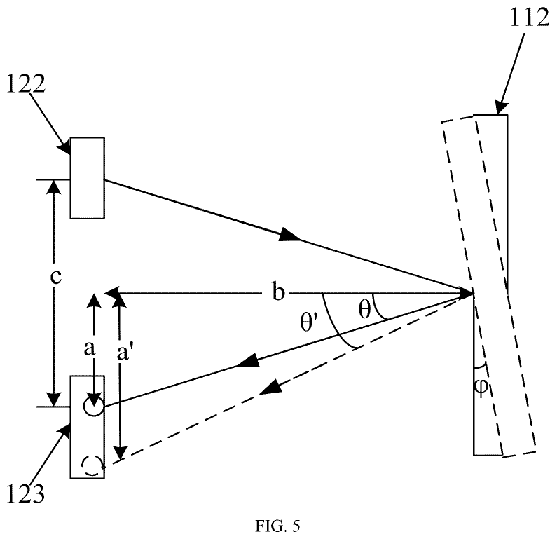

As shown in FIG. 5, for the above S1, combined with the principle of light reflection and trigonometric functions, the calculation process of the rotation angle of the reflective surface 112 is as follows:

$$a = c / 2 ; \qquad ( formula 1 )$$

$$θ = arctg ( a / b ) ; \qquad ( formula 2 )$$

$${θ}^{′} = arctg ( {a}^{′} / b ) ; \qquad ( formula 3 )$$

$$ϕ = ( {θ}^{′} - θ ) / 2. \qquad ( formula 4 )$$

c is the distance between the light transmitter 122 and the standard position of the light spot.
a is half of the distance between the light transmitter 122 and the standard position of the light spot.
a′ is the sum of “a” and the change in the light spot after the smart glasses are deformed, and the change in the light spot refers to the offset of the position of the light spot when the smart glasses are deformed relative to the position of the light spot when the smart glasses are not deformed.
b is the distance between the plane where the light transmitter 122 is located and the plane where the reflective surface 112 is located.
θ is the reflection angle of the light when the smart glasses are not deformed;
θ′ is the angle between the reflected light when the smart glasses are deformed and the normal of the reflective surface 112 when the smart glasses are not deformed;
ϕ is the rotation angle of the reflective surface 112.

For the above S2, on the basis of the standard position of the reflective surface 112, the reflective surface 112 is rotated in the set direction, and the rotation angle can be equal to the rotation angle determined based on the above step S1, so that the deformation position of the reflective surface 112 can be determined. The set direction is the deformation direction of the smart glasses when they are deformed due to wearing. It can be understood that the set direction is usually fixed.

For the above S3, the deformation position of the first optical machine 111 is determined according to the relative position relationship between the reflective surface 112 and the first optical machine 111 and the deformation position of the reflective surface 112.

According to the relative position relationship between the reflective surface 112 and the first optical machine 111, it can be obtained according to the ratio between the standard position of the reflective surface 112 and the standard position of the first optical machine 111.

It should be noted that the solid circle in FIG. 5 is the actual position of the light spot when the smart glasses are not deformed, that is, the standard position of the light spot. The dotted circle in FIG. 5 is the actual position of the light spot when the smart glasses are deformed, that is, the deformation position of the light spot. The dotted line with an arrow in FIG. 5 is the reflected light after the smart glasses are deformed. The dotted rectangle in FIG. 5 is the position of the smart glasses after deformation.

In an embodiment of the present application, the light transmitter 122 is an infrared light transmitter or a laser emitter, or other light transmitters with high collimation.

In the case where the light transmitter 122 is an infrared light transmitter or a laser emitter, the cost of the smart glasses provided in the embodiment of the present application can be reduced.

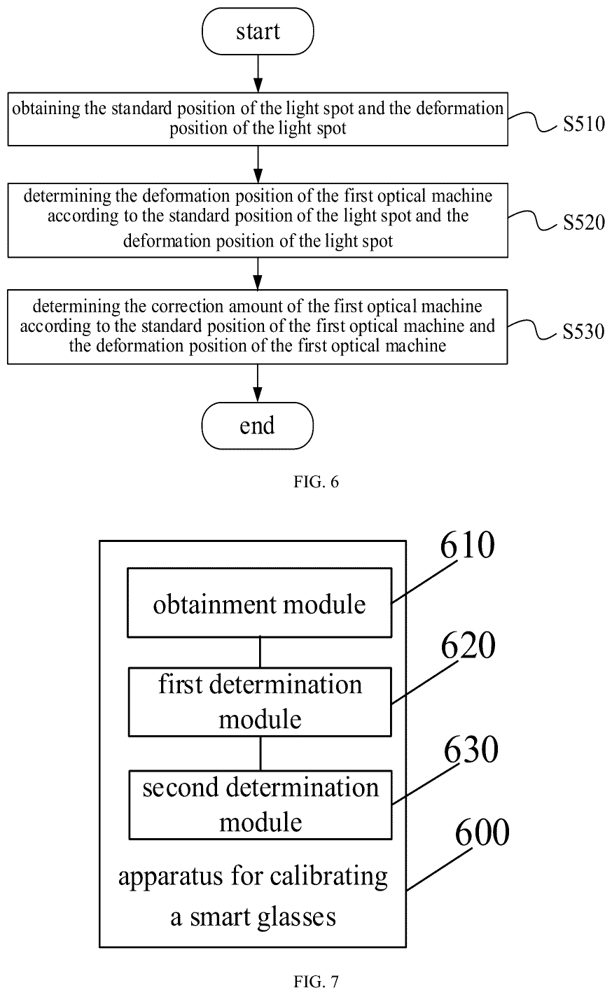

The present application also provides a method for calibrating a smart glasses, which is applied to the smart glasses provided in any of the above embodiments. As shown in FIG. 6, the method for calibrating a smart glasses provided in the embodiment of the present application includes the following S510-S530:
S510, obtaining the standard position of the light spot and the deformation position of the light spot;
S520, determining the deformation position of the first optical machine according to the standard position of the light spot and the deformation position of the light spot; and
S530, determining the correction amount of the first optical machine according to the standard position of the first optical machine and the deformation position of the first optical machine;
the light emitted by the light transmitter is reflected by the reflective surface to the light receiver to form the light spot.

In an embodiment of the present application, the method for calibrating a smart glasses provided in the embodiment of the present application further includes the following steps before the above S510:
obtaining a wearing state of the smart glasses; and
in response to that the wearing state is being worn, turning on the light transmitter and the light receiver.

In an embodiment of the present application, the above S520 includes the following steps:
determining a rotation angle of the reflective surface according to the standard position of the light spot and the deformation position of the light spot;
determining a deformation position of the reflective surface according to the rotation angle and a standard position of the reflective surface; and
determining a deformation position of the first optical machine according to the deformation position of the reflective surface.

The present application also provides an apparatus for calibrating a smart glasses 600, the smart glasses are the smart glasses described in any of the above embodiments, as shown in FIG. 7, the apparatus for calibrating a smart glasses 600 includes: an obtainment module 610, a first determination module 620 and a second determination module 630.

The obtainment module 610 is configured to obtain the standard position of the light spot and the deformation position of the light spot.

The first determination module 620 is configured to determine the deformation position of the first optical machine according to the standard position of the light spot and the deformation position of the light spot.

The second determination module 630 is configured to determine the correction amount of the first optical machine according to the standard position of the first optical machine and the deformation position of the first optical machine.

The light emitted by the light transmitter is reflected by the reflective surface to the light receiver to form the light spot.

In an embodiment of the present application, the apparatus for calibrating a smart glasses 600 provided in the embodiment of the present application also includes:
an opening module, configured to obtain the wearing state of the smart glasses; and in response to that the wearing state is being worn, turning on the light transmitter and the light receiver.

In an embodiment of the present application, the first determination module 620 is specifically configured to:
determine the rotation angle of the reflective surface according to the standard position of the light spot and the deformation position of the light spot;
determine the deformation position of the reflective surface according to the rotation angle and the standard position of the reflective surface;
determine the deformation position of the first optical machine according to the deformation position of the reflective surface.

The present application also provides a smart glasses 700, which includes an apparatus for calibrating a smart glasses described in any of the above embodiments.

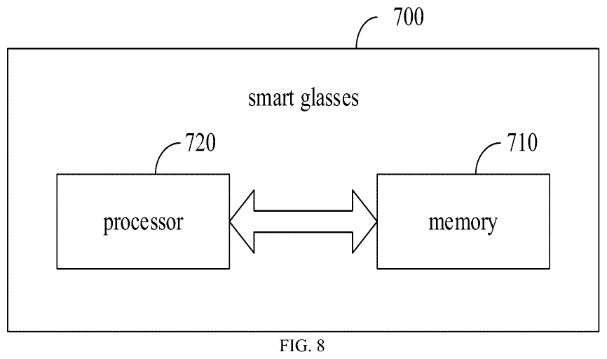

Or, as shown in FIG. 8, it includes a memory 710 and a processor 720, the memory 710 is used to store a computer program for calibrating a smart glasses, and the processor 720 is used to call the a computer program for calibrating a smart glasses from the memory 710 to execute the method for calibrating a smart glasses described in any of the above method embodiments.

The present application also provides a computer-readable storage medium, on which a computer program for calibrating a smart glasses is stored, and when the computer program for calibrating a smart glasses is executed by the processor, the method for calibrating a smart glasses according to any of the above method embodiments is implemented.

The various embodiments in the specification are described in parallel or progressively, and each embodiment focuses on the differences from other embodiments, and the same or similar parts between the various embodiments can be referred to each other. For the device disclosed in the embodiment, since it corresponds to the method disclosed in the embodiment, the description is relatively simple, and the relevant parts can be referred to the method part description.

Those skilled in the art can also understand that the units and algorithm steps of each example described in the embodiment disclosed in this article can be implemented by electronic hardware, computer software or a combination of the two. In order to clearly illustrate the interchangeability of hardware and software, the composition and steps of each example have been generally described in the above description according to the function. Whether these functions are executed in hardware or software depends on the specific application and design constraints of the technical solution. Those skilled in the art can use different methods to implement the described functions for each specific application, but such implementation should not be considered to be beyond the scope of this application.

The steps of the method or algorithm described in the embodiment disclosed in this article can be directly implemented by hardware, software modules executed by a processor, or a combination of the two. The software module can be placed in a random access memory (RAM), a memory, a read-only memory (ROM), an electrically programmable ROM, an electrically erasable programmable ROM, a register, a hard disk, a removable disk, a CD-ROM, or any other form of storage medium known in the technical field.

It should also be noted that, in this article, relational terms such as first and second, etc. are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “comprise a . . . ” do not exclude the presence of other identical elements in the process, method, article or device including the elements.

The above are only some embodiments of the present application, and do not limit the scope of the present application thereto. Under the inventive concept of the present application, equivalent structural transformations made according to the description and drawings of the present application, or direct/indirect application in other related technical fields, are included in the scope of the present application.

What is claimed is:

1. A smart glasses, comprising:
a first frame;
a second frame; and
a processing device,
wherein the first frame is provided with a reflective surface and a first optical machine, and a relative position between the reflective surface and the first optical machine is fixed;
the second frame is provided with a light transmitter, a light receiver and a second optical machine, and a relative position between the light transmitter, the light receiver and the second optical machine is fixed;
the processing device is electrically connected to the light transmitter and the light receiver, respectively, and the processing device is configured for:
obtaining a standard position of a light spot and a deformation position of the light spot;
determining a deformation position of the first optical machine according to the standard position of the light spot and the deformation position of the light spot; and
determining a correction amount of the first optical machine according to the standard position of the first optical machine and the deformation position of the first optical machine; and
light emitted by the light transmitter is reflected by the reflective surface to the light receiver to form the light spot.

2. The smart glasses according to claim 1, wherein the processing device is further configured for:
obtaining a wearing state of the smart glasses; and
in response to that the wearing state is being worn, turning on the light transmitter and the light receiver.

3. The smart glasses according to claim 1, wherein the determining the deformation position of the first optical machine according to the standard position of the light spot and the deformation position of the light spot comprises:
determining a rotation angle of the reflective surface according to the standard position of the light spot and the deformation position of the light spot;
determining a deformation position of the reflective surface according to the rotation angle and a standard position of the reflective surface; and
determining the deformation position of the first optical machine according to the deformation position of the reflective surface.

4. The smart glasses according to claim 1, wherein the light transmitter is an infrared light transmitter or a laser transmitter.

5. A method for calibrating a smart glasses, applied to the smart glasses according to claim 1, comprising:
obtaining the standard position of the light spot and the deformation position of the light spot;
determining the deformation position of the first optical machine according to the standard position of the light spot and the deformation position of the light spot; and
determining the correction amount of the first optical machine according to the standard position of the first optical machine and the deformation position of the first optical machine;
wherein the light emitted by the light transmitter is reflected by the reflective surface to the light receiver to form the light spot.

6. The method according to claim 5, wherein before the obtaining the standard position of the light spot and the deformation position of the light spot, the method further comprises:
obtaining a wearing state of the smart glasses; and
in response to that the wearing state is being worn, turning on the light transmitter and the light receiver.

7. The method according to claim 5, wherein the determining the deformation position of the first optical machine according to the standard position of the light spot and the deformation position of the light spot comprises:
determining a rotation angle of the reflective surface according to the standard position of the light spot and the deformation position of the light spot;
determining a deformation position of the reflective surface according to the rotation angle and a standard position of the reflective surface; and
determining the deformation position of the first optical machine according to the deformation position of the reflective surface.

8. An apparatus for calibrating a smart glasses, applied to the smart glasses according to claim 1, comprising:
an obtainment module, configured to obtain the standard position of the light spot and the deformation position of the light spot;
a first determination module, configured to determine the deformation position of the first optical machine according to the standard position of the light spot and the deformation position of the light spot; and
a second determination module, configured to determine the correction amount of the first optical machine according to the standard position of the first optical machine and the deformation position of the first optical machine,
wherein the light emitted by the light transmitter is reflected by the reflective surface to the light receiver to form the light spot.

9. A smart glasses, comprising:
the apparatus for calibrating the smart glasses according to claim 8.

10. A smart glasses, comprising:
a memory; and
a processor,
wherein a computer instruction is stored in the memory, and the processor is configured to call the computer instruction from the memory to execute the method for calibrating the smart glasses according to claim 5.

11. A non-transitory computer-readable storage medium, wherein a computer program is stored in the non-transitory computer-readable storage medium, and the computer program, when executed by a processor, implements the method for calibrating the smart glasses according to claim 5.
